(19) United States
(12) Patent Application Publication
(10) Pub. No.: US 2007/0288898 A1
(43) Pub. Date: Dec. 13, 2007

(54) Methods, electronic devices, and computer program products for setting a feature of an electronic device based on at least one user characteristic

(75) Inventor: Peter Claes Isberg, Lund (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/450,094

(22) Filed: Jun. 9, 2006

(51) Int. Cl. G06F 9/44

(52) U.S. Cl. 717/124

(57) ABSTRACT

An electronic device includes a user characteristic module that is configured to analyze at least one characteristic of a user and to set a feature of the electronic device based on the analysis of the at least one characteristic.

### BACKGROUND OF THE INVENTION

The present invention relates to electronic devices, and, more particularly, to methods, electronic devices, and computer program products for setting a feature in an electronic device.

An emoticon is a sequence of ordinary printable ASCII characters, such as :-), ;o), ̂_̂ or :-(, or a small image, intended to represent a human expression and/or convey an emotion. Emoticons may be considered a form of paralanguage and are common used in electronic mail messages, online bulletin boards, online forums, instant messages, and/or in chat rooms. Such emoticons can often provide context for associated statements to ensure that the writer's message is interpreted correctly. Graphic emoticons, which are small images that often automatically replace typed text, may be used in addition to or in place of the text based emoticons described above. Graphic emoticons are often used on Internet forums and/or in instant messenger programs.

### SUMMARY OF THE INVENTION

According to some embodiments of the present invention, an electronic device includes a user characteristic module that is configured to analyze at least one characteristic of a user and to set a feature of the electronic device based on the analysis of the at least one characteristic.

In other embodiments, the electronic device further comprises a microphone that is configured to capture speech from the user. The user characteristic module includes a voice analysis module that is configured to analyze the captured speech so as to determine a mood associated with the user and to set the feature of the electronic device based on the determined mood.

In still other embodiments, the user characteristic module is further configured to make the determined mood accessible to others via a communication network.

In still other embodiments, the voice analysis module is configured to perform a textual analysis of the captured speech so as to determine the mood associated with the user.

In still other embodiments, the voice analysis module includes a speech recognition module that is configured to generate text responsive to the captured speech, a text correlation module that is configured to correlate the generated text with stored words and/or phrases, and a mood detection module that is configured to determine the mood associated with the user based on the correlation between the generated text and the stored words and/or phrases.

In still other embodiments, the voice analysis module is configured to perform an audio analysis of the captured speech so as to determine the mood associated with the user.

In still other embodiments, the voice analysis module includes a spectral analysis module that is configured to determine frequencies and/or loudness levels associated with the captured speech, a spectral correlation module that is configured to correlate the determined frequencies and/or loudness levels with frequency and/or loudness patterns, and a mood detection module that is configured to determine the mood associated with the user based on the correlation between the determined frequencies and/or loudness levels and the frequency and/or loudness patterns.

In still other embodiments, the voice analysis module is configured to perform a textual and an audio analysis of the captured speech so as to determine the mood associated with the user.

In still other embodiments, the electronic device further includes a camera that is configured to capture an image of the user. The user characteristic module includes an image analysis module that is configured to analyze the captured image so as to determine a mood associated with the user and to set the feature of the electronic device based on the determined mood.

In still other embodiments, the user characteristic module is further configured to make the determined mood accessible to others via a communication network.

In still other embodiments, the image analysis module includes an expression analysis module that is configured to determine at least one expression associated with the image, a pattern correlation module that is configured to correlate the determined at least one expression with patterns of expression, and a mood detection module that is configured to determine the mood associated with the user based on the correlation between the determined at least one expression and the patterns of expression.

In still other embodiments, the electronic device further includes a video camera that is configured to capture a video image of the user. The user characteristic module includes a video analysis module that is configured to analyze the captured video image so as to determine a mood associated with the user and to set the feature of the electronic device based on the determined mood.

In still other embodiments, the user characteristic module is further configured to make the determined mood accessible to others via a communication network.

In still other embodiments, the video analysis module includes an expression analysis module that is configured to determine at least one expression associated with the video image, a pattern correlation module that is configured to correlate the determined at least one expression with patterns of expression, and a mood detection module that is configured to determine the mood associated with the user based on the correlation between the determined at least one expression and the patterns of expression.

In still other embodiments, the electronic device is a mobile terminal.

In still other embodiments, the feature of the mobile terminal includes a ringtone, a background display image, a displayed icon, and/or an icon associated with a transmitted message.

In further embodiments, an electronic device is operated by analyzing at least one characteristic of a user of the electronic device, and setting a feature of the electronic device based on the analysis of the at least one characteristic.

In still further embodiments, the electronic device is operated by capturing speech from the user, analyzing the captured speech so as to determine a mood associated with the user, and setting the feature of the electronic device based on the determined mood.

In still further embodiments, the determined mood is made accessible to others via a communication network.

In still further embodiments, analyzing the captured speech includes performing a textual analysis of the captured speech so as to determine the mood associated with the user.

In still further embodiments, performing the textual analysis includes generating text responsive to the captured speech, correlating the generated text with stored words and/or phrases, and determining the mood associated with the user based on the correlation between the generated text and the stored words and/or phrases.

In still further embodiments, analyzing the captured speech includes performing an audio analysis of the captured speech so as to determine the mood associated with the user.

In still further embodiments, performing the audio analysis includes determining frequencies and/or loudness levels associated with the captured speech, correlating the determined frequencies and/or loudness levels with frequency and/or loudness patterns, and determining the mood associated with the user based on the correlation between the determined frequencies and/or loudness levels and the frequency and/or loudness patterns.

In still further embodiments, analyzing the captured speech includes performing a textual and an audio analysis of the captured speech so as to determine the mood associated with the user.

In still further embodiments, operating the electronic device further comprises capturing an image of the user, analyzing the captured image so as to determine a mood associated with the user, and setting the feature of the electronic device based on the determined mood.

In still further embodiments, the determined mood is made accessible to others via a communication network.

In still further embodiments, analyzing the captured image includes determining at least one expression associated with the image, correlating the determined at least one expression with patterns of expression, and determining the mood associated with the user based on the correlation between the determined at least one expression and the patterns of expression.

In still further embodiments, operating the electronic device further includes capturing a video image of the user, analyzing the captured video image so as to determine a mood associated with the user, and setting the feature of the electronic device based on the determined mood.

In still further embodiments, the determined mood is made accessible to others via a communication network.

In still further embodiments, analyzing the captured video image includes determining at least one expression associated with the video image, correlating the determined at least one expression with patterns of expression, and determining the mood associated with the user based on the correlation between the determined at least one expression and the patterns of expression.

In still further embodiments, the electronic device is a mobile terminal

In still further embodiments, the feature of the mobile terminal comprises a ringtone, a background display image, a displayed icon, and/or an icon associated with a transmitted message.

In other embodiments a computer program product for operating an electronic device includes a computer readable storage medium having computer readable program code embodied therein. The computer readable program code includes computer readable program code configured to analyze at least one characteristic of a user of the electronic device, and computer readable program code configured to set a feature of the electronic device based on the analysis of the at least one characteristic.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates an electronic device/mobile terminal in accordance with some embodiments of the present invention;

FIG. 2 is a block diagram that illustrates speech and video/image analysis modules in accordance with some embodiments of the present invention; and

FIGS. 3 and 4 are flow charts that illustrate setting a feature of an electronic device/mobile terminal based on at least one user characteristic in accordance with some embodiments of the present invention.

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, electronic devices, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

For purposes of illustration, embodiments of the present invention are described herein in the context of a mobile terminal. It will be understood, however, that the present invention is not limited to such embodiments and may be embodied generally as an electronic device that has one or more configurable features.

Some embodiments of the present invention stem from a realization that a mobile terminal user's mood may be detected based on the user's speech and/or image and such mood information may be used to set one or more features of the mobile terminal, such as, but not limited to, a ringtone, a background display image, a displayed icon, an icon associated with a transmitted message, and/or other themes associated with the mobile terminal.

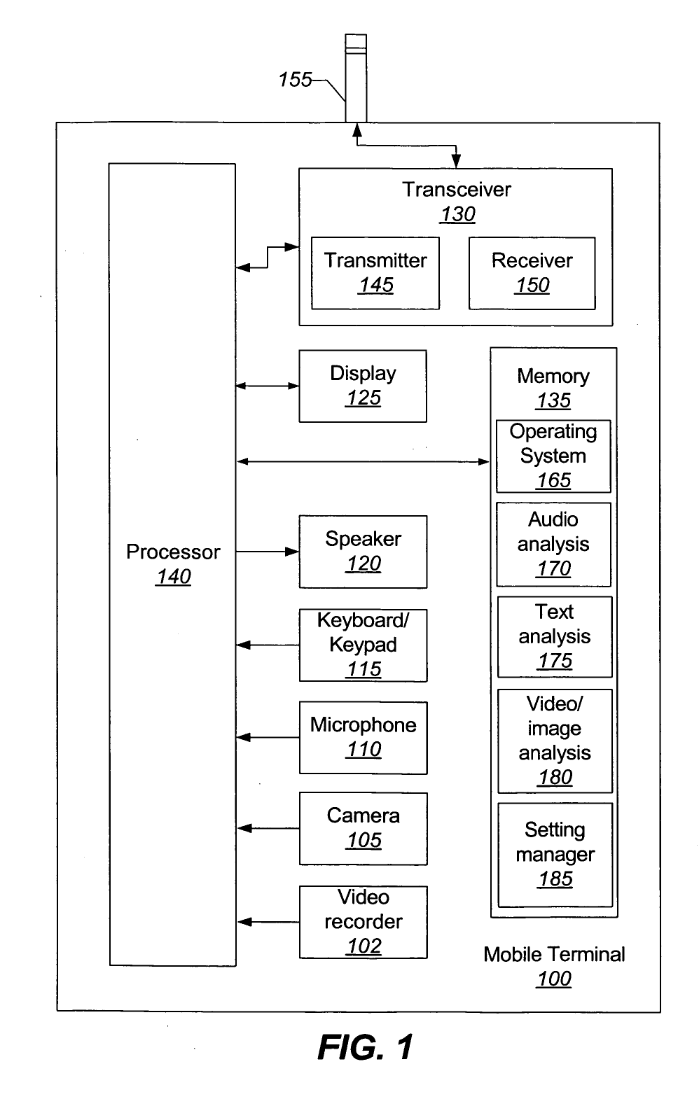

Referring now to FIG. 1, an exemplary mobile terminal 100, in accordance with some embodiments of the present invention, comprises a video recorder 102, a camera 105, a microphone 110, a keyboard/keypad 115, a speaker 120, a display 125, a transceiver 130, and a memory 135 that communicate with a processor 140. The transceiver 130 comprises a transmitter circuit 145 and a receiver circuit 150, which respectively transmit outgoing radio frequency signals to base station transceivers and receive incoming radio frequency signals from the base station transceivers via an antenna 155. The radio frequency signals transmitted between the mobile terminal 100 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 100 may be included in many conventional mobile terminals and their functionality is generally known to those skilled in the art.

The processor 140 communicates with the memory 135 via an address/data bus. The processor 140 may be, for example, a commercially available or custom microprocessor. The memory 135 is representative of the one or more memory devices containing the software and data used to set a feature of the mobile terminal 100 based on an analysis of one or more characteristics of a user, such as a user's voice or expression, which may be indicative of the user's mood, in accordance with some embodiments of the present invention. The memory 135 may include, but is not limited to, the following types of devices: cache, ROM, PROM, EPROM, EEPROM, flash, SRAM, and DRAM.

As shown in FIG. 1, the memory 135 may contain up to five or more categories of software and/or data: the operating system 165, an audio analysis module, a text analysis module 175, a video/image analysis module 180, and a setting manager module 185. The operating system 165 generally controls the operation of the mobile terminal 100. In particular, the operating system 165 may manage the mobile terminal's software and/or hardware resources and may coordinate execution of programs by the processor 140. The audio analysis module 170 and text analysis module 175 may collectively comprise a voice analysis module that is configured to analyze a user's speech captured by the microphone 110 so as to determine a mood associated with the user. The audio analysis module 170 may be configured to perform an audio analysis of a user's speech by performing a spectral analysis of the frequencies and/or loudness levels associated with the user's voice. The text analysis module 175 may be configured to perform a textual analysis of a user's speech by using speech recognition, for example, to generate text that can be correlated with stored words and/or phrases. The video/image analysis module 180 may be configured to perform an analysis of an image and/or video image of a user captured by the camera 105 and/or the video recorder 102, respectively, so as to determine a mood associated with the user. The audio analysis module 170, text analysis module 175, and/or video/image analysis module 180 may be considered user characteristic modules as they are used to analyze characteristics of a user of the mobile terminal 100. The setting manager 185 may cooperate with the audio analysis module 170, the text analysis module 175, and/or the video/image analysis module 180 to set one or more features of the mobile terminal 100 based on the determined mood of the user. For example, the setting manager 185 may be used to set such features of the mobile terminal as, but not limited to, a ringtone, a background display image, a displayed icon, and/or an icon associated with a transmitted message.

Although FIG. 1 illustrates an exemplary software and hardware architecture that may be used for setting a feature of a mobile terminal based on an analysis of one or more characteristics of a user, such as a user's voice or expression, which may be indicative of the user's mood, it will be understood that the present invention is not limited to such a configuration but is intended to encompass any configuration capable of carrying out the operations described herein.

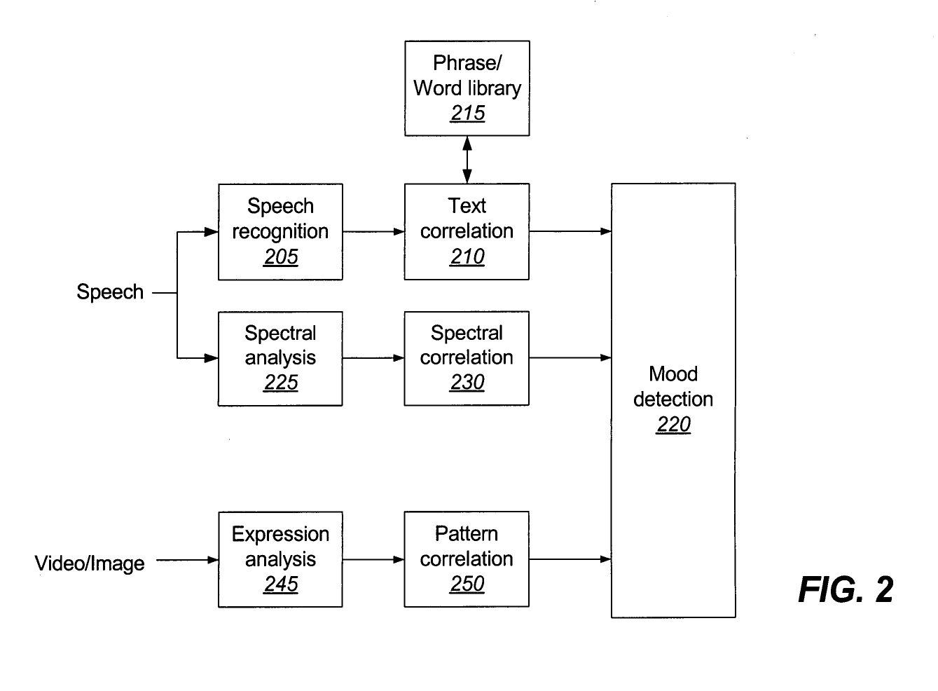

FIG. 2 is a block diagram that illustrates the audio analysis module 170, the text analysis module 175 and the video/image analysis module 180 of FIG. 1 in more detail in accordance with some embodiments of the present invention. A user's speech can be captured by the microphone 110 and provided to a speech recognition module 205 that is configured to generate text responsive to the captured speech. A text correlation module 210 may then process the generated text by correlating the generated text with words and/or phrases that are stored in the phrase/word library 215. For example, words and/or phrases from the generated text may be correlated with words and/or phrases in the phrase/word library 215 that have moods, such as angry, happy, sad, afraid, and the like associated with them. Based on the correlations established between the generated text and the phrases/words from the library 215, a mood detection module 220 may determine a mood associated with the user. As discussed above, the setting manager 185 may then be used to set one or more features of the mobile terminal 100 based on the determined mood of the user.

A user's speech may also be analyzed spectrally by the spectral analysis module 225. That is, the spectral analysis module 225 may determine frequencies and/or loudness levels associated with the captured speech. A spectral correlation module 230 may correlate the determined frequencies and/or loudness levels with frequency and/or loudness patterns that are indicative of a user's mood, such as angry, happy, sad, afraid, and the like. The mood detection module 220 may determine a mood associated with the user based on the correlation between the frequencies and/or loudness levels and the patterns that are indicative of a user's mood.

An image of the user captured by the camera 105 and/or a video image of the user captured by the video recorder 102 may be provided to an expression analysis module 215 that may determine one or more expressions associated with the image. The expressions may be, for example, but not limited to, a smile, a frown, an eye configuration, a wrinkle/dimple configuration, and the like. A pattern correlation module 250 may correlate the determined expression(s) with one or more patterns of expression that are indicative of a user's mood, such as angry, happy, sad, afraid, and the like. The mood detection module 220 may determine a mood associated with the user based on the correlation between the determined user expression(s) and the patterns of expression that are indicative of a user's mood.

Although FIGS. 1 and 2 illustrate exemplary hardware/software architectures that may be used in mobile terminals, electronic devices, and the like for setting a feature of the mobile terminal 100 based on an analysis of one or more characteristics of a user, such as a user's voice or expression, which may be indicative of the user's mood, it will be understood that the present invention is not limited to such a configuration but is intended to encompass any configuration capable of carrying out operations described herein. Moreover, the functionality of the hardware/software architecture of FIGS. 1 and 2 may be implemented as a single processor system, a multi-processor system, or even a network of stand-alone computer systems, in accordance with various embodiments of the present invention.

Computer program code for carrying out operations of devices and/or systems discussed above with respect to FIGS. 1 and 2 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of methods, mobile terminals, electronic devices, data processing systems, and/or computer program products in accordance with some embodiments of the invention.

These flowchart and/or block diagrams further illustrate exemplary operations of setting a feature of a mobile terminal based on an analysis of one or more characteristics of a user, such as a user's voice or expression, which may be indicative of the user's mood, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

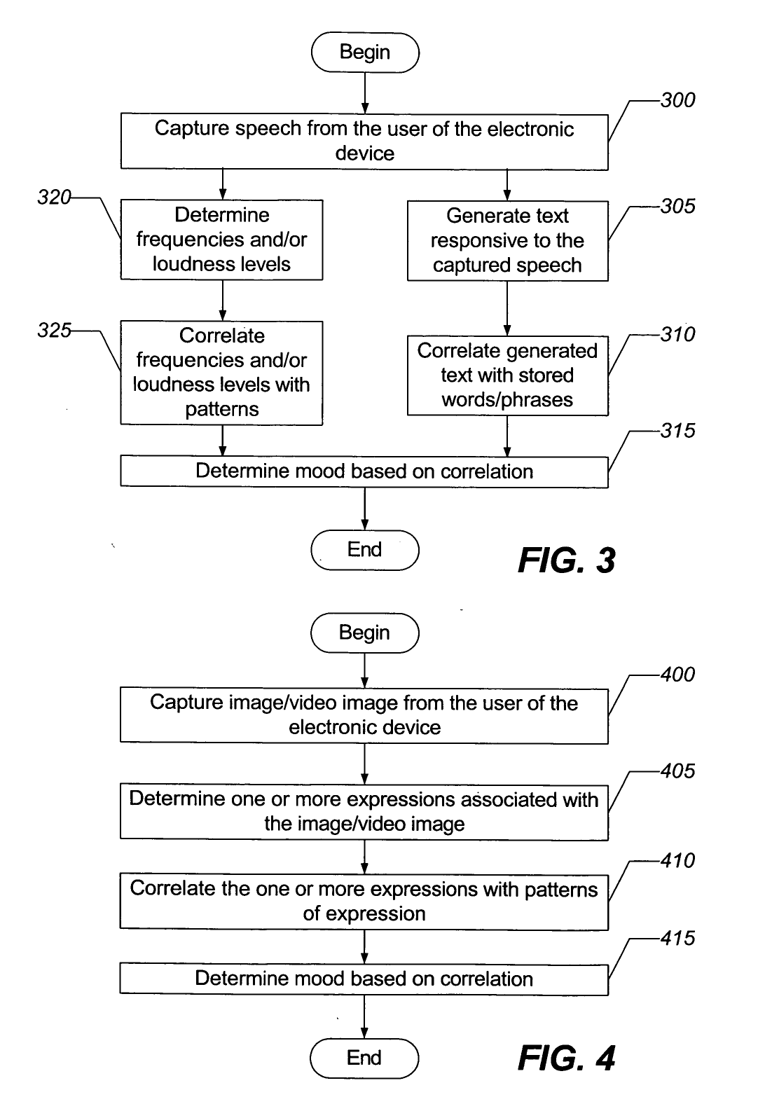

Referring now to FIG. 3, operations for analyzing the captured speech of a user so as to determine a mood associated with the user and to set a feature of a mobile terminal based on the determined mood begin at block 300 where the speech is captured, for example, using the microphone 110 of FIG. 1. At block 305, a textual analysis of the captured speech can be performed by generating text responsive to the captured speech using the speech recognition module 205 of FIG. 2. The generated text can be correlated with stored words/phrases at block 310 using the text correlation module 210 and phrase/word library 215 of FIG. 2. A user's mood may then be determined at block 315 based on the correlation performed at block 310 using the mood detection module 220 of FIG. 2.

In addition to or instead of performing a textual analysis of the captured speech, the frequencies and/or loudness levels of the captured speech can be determined at block 320 using the spectral analysis module 225 of FIG. 2. The spectral analysis module 225 may be, for example, a fast Fourier transform (FFT) module in some embodiments. The determined frequencies and/or loudness levels of the captured speech can be correlated with frequency and/or loudness patterns at block 325 using the spectral correlation module 230 of FIG. 2. A user's mood may then be determined at block 315 based on the correlation performed at block 325 using the mood detection module 220 of FIG. 2.

Referring now to FIG. 4, operations for analyzing the captured image and/or video image of a user so as to determine a mood associated with the user and to set a feature of a mobile terminal based on the determined mood begin at block 400 where the image/video image is captured, for example, using the camera 105 and/or video recorder 102 of FIG. 1. One or more expressions associated with the captured image/video image are determined at block 405 using, for example, the expression analysis module 245 of FIG. 2. At block 410, one or more of the determined user expressions are correlated with patterns of expression using, for example, the pattern correlation module 250 of FIG. 2. A user's mood may then be determined at block 415 based on the correlation performed at block 410 using the mood detection module 220 of FIG. 2.

It will be understood that, in accordance with various embodiments of the present invention, a voice/speech analysis may be performed on a user's captured speech, an image/video image analysis may be performed on a user's captured image/video image, or both a voice/speech analysis and an image/video image analysis may be performed to determine a user's mood. Moreover, when performing a voice/speech analysis, a text analysis may be performed, a spectral analysis may be performed, or both a text analysis and a spectral analysis may be performed to determine a user's mood.

Advantageously, some embodiments of the present invention may allow devices, such as mobile terminals, to detect a user's mood and incorporate that information in one or more features of the device, such as ringtones, display backgrounds, icons in messages, and/or other themes of the device.

In further embodiments of the present invention, a user's mood may be made available to others to see via, for example, various services on the Internet. One type of service may be an instant messaging service in which a person may see which friends of him/her are online at the moment along with their moods, which may be determined as discussed above. Another type of service may be a push-to-talk service in which a person can see which friends are available for communication, e.g., online, and their moods before the person attempts to set up a push-to-talk session. In other embodiments, conventional messaging, instant messaging, and/or push-to-talk services may be combined.

The flowcharts of FIGS. 3 and 4 illustrate the architecture, functionality, and operations of embodiments of methods, electronic devices, and/or computer program products for setting a feature of a mobile terminal based on an analysis of one or more characteristics of a user, such as a user's voice or expression, which may be indicative of the user's mood. In this regard, each block represents a module, segment, or portion of code, which comprises one or more executable instructions for implementing the specified logical function(s). It should also be noted that in other implementations, the function(s) noted in the blocks may occur out of the order noted in FIGS. 3 and 4. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

That which is claimed:

1. An electronic device, comprising:
a user characteristic module that is configured to analyze at least one characteristic of a user and to set a feature of the electronic device based on the analysis of the at least one characteristic.

2. The electronic device of claim 1, further comprising:
a microphone that is configured to capture speech from the user;
wherein the user characteristic module comprises a voice analysis module that is configured to analyze the captured speech so as to determine a mood associated with the user and to set the feature of the electronic device based on the determined mood.

3. The electronic device of claim 2, wherein the user characteristic module is further configured to make the determined mood accessible to others via a communication network.

4. The electronic device of claim 2, wherein the voice analysis module is configured to perform a textual analysis of the captured speech so as to determine the mood associated with the user.

5. The electronic device of claim 4, wherein the voice analysis module comprises:
a speech recognition module that is configured to generate text responsive to the captured speech;
a text correlation module that is configured to correlate the generated text with stored words and/or phrases; and
a mood detection module that is configured to determine the mood associated with the user based on the correlation between the generated text and the stored words and/or phrases.

6. The electronic device of claim 2, wherein the voice analysis module is configured to perform an audio analysis of the captured speech so as to determine the mood associated with the user.

7. The electronic device of claim 6, wherein the voice analysis module comprises:
a spectral analysis module that is configured to determine frequencies and/or loudness levels associated with the captured speech;
a spectral correlation module that is configured to correlate the determined frequencies and/or loudness levels with frequency and/or loudness patterns; and
a mood detection module that is configured to determine the mood associated with the user based on the correlation between the determined frequencies and/or loudness levels and the frequency and/or loudness patterns.

8. The electronic device of claim 2, wherein the voice analysis module is configured to perform a textual and an audio analysis of the captured speech so as to determine the mood associated with the user.

9. The electronic device of claim 1, further comprising:
a camera that is configured to capture an image of the user;
wherein the user characteristic module comprises an image analysis module that is configured to analyze the captured image so as to determine a mood associated with the user and to set the feature of the electronic device based on the determined mood.

10. The electronic device of claim 9, wherein the user characteristic module is further configured to make the determined mood accessible to others via a communication network.

11. The electronic device of claim 9, wherein the image analysis module comprises:
an expression analysis module that is configured to determine at least one expression associated with the image;
a pattern correlation module that is configured to correlate the determined at least one expression with patterns of expression; and
a mood detection module that is configured to determine the mood associated with the user based on the correlation between the determined at least one expression and the patterns of expression.

12. The electronic device of claim 1, further comprising:
a video camera that is configured to capture a video image of the user;
wherein the user characteristic module comprises a video analysis module that is configured to analyze the captured video image so as to determine a mood associated with the user and to set the feature of the electronic device based on the determined mood.

13. The electronic device of claim 12, wherein the user characteristic module is further configured to make the determined mood accessible to others via a communication network.

14. The electronic device of claim 12, wherein the video analysis module comprises:
an expression analysis module that is configured to determine at least one expression associated with the video image;
a pattern correlation module that is configured to correlate the determined at least one expression with patterns of expression; and
a mood detection module that is configured to determine the mood associated with the user based on the correlation between the determined at least one expression and the patterns of expression.

15. The electronic device of claim 1, wherein the electronic device is a mobile terminal.

16. The electronic device of claim 15, wherein the feature of the mobile terminal comprises a ringtone, a background display image, a displayed icon, and/or an icon associated with a transmitted message.

17. A method of operating an electronic device, comprising:
analyzing at least one characteristic of a user of the electronic device; and
setting a feature of the electronic device based on the analysis of the at least one characteristic.

18. The method of claim 17, further comprising:
capturing speech from the user;
wherein analyzing the at least one characteristic of the user comprises analyzing the captured speech so as to determine a mood associated with the user; and
wherein setting the feature comprises setting the feature of the electronic device based on the determined mood.

19. The method of claim 18, further comprising:
making the determined mood accessible to others via a communication network.

20. The method of claim 19, wherein analyzing the captured speech comprises performing a textual analysis of the captured speech so as to determine the mood associated with the user.

21. The method of claim 20, wherein performing the textual analysis comprises:
generating text responsive to the captured speech;
correlating the generated text with stored words and/or phrases; and
determining the mood associated with the user based on the correlation between the generated text and the stored words and/or phrases.

22. The method of claim 18, wherein analyzing the captured speech comprises performing an audio analysis of the captured speech so as to determine the mood associated with the user.

23. The method of claim 22, wherein performing the audio analysis comprises:
determining frequencies and/or loudness levels associated with the captured speech;
correlating the determined frequencies and/or loudness levels with frequency and/or loudness patterns; and
determining the mood associated with the user based on the correlation between the determined frequencies and/or loudness levels and the frequency and/or loudness patterns.

24. The method of claim 18, wherein analyzing the captured speech comprises performing a textual and an audio analysis of the captured speech so as to determine the mood associated with the user.

25. The method of claim 17, further comprising:
capturing an image of the user;
wherein analyzing the at least one characteristic of the user comprises analyzing the captured image so as to determine a mood associated with the user; and
wherein setting the feature comprises setting the feature of the electronic device based on the determined mood.

26. The method of claim 25, further comprising:
making the determined mood accessible to others via a communication network.

27. The method of claim 25, wherein analyzing the captured image comprises:
determining at least one expression associated with the image;
correlating the determined at least one expression with patterns of expression; and
determining the mood associated with the user based on the correlation between the determined at least one expression and the patterns of expression.

28. The method of claim 17, further comprising:
capturing a video image of the user;
wherein analyzing the at least one characteristic of the user comprises analyzing the captured video image so as to determine a mood associated with the user; and
wherein setting the feature comprises setting the feature of the electronic device based on the determined mood.

29. The method of claim 28, further comprising:
making the determined mood accessible to others via a communication network.

30. The method of claim 28, wherein analyzing the captured video image comprises:
determining at least one expression associated with the video image;
correlating the determined at least one expression with patterns of expression; and
determining the mood associated with the user based on the correlation between the determined at least one expression and the patterns of expression.

31. The method of claim 17, wherein the electronic device is a mobile terminal.

32. The method of claim 31, wherein the feature of the mobile terminal comprises a ringtone, a background display image, a displayed icon, and/or an icon associated with a transmitted message.

33. A computer program product for operating an electronic device, comprising:
a computer readable storage medium having computer readable program code embodied therein, the computer readable program code comprising:
computer readable program code configured to analyze at least one characteristic of a user of the electronic device; and
computer readable program code configured to set a feature of the electronic device based on the analysis of the at least one characteristic.
